(19) United States
(12) Patent Application Publication
(10) Pub. No.: US 2002/0182043 A1
(43) Pub. Date: Dec. 5, 2002

(54) Refuse Collection vehicle with multiple compartments

(76) Inventors: Mike Anderson, Toccoa, GA (US); John Duell, Westminster, SC (US)

Correspondence Address: Robert B. Kennedy, Baker, Donelson, Bearman & Caldwell, Suite 900, Five Concourse Parkway, Atlanta, GA, 30328, US

(21) Appl. No.: 09/867,559

(22) Filed: May 31, 2001

(51) Int. Cl. B60P 1/16

(52) U.S. Cl. 414/469; 296/184; 410/130; 298/22 R

(57) ABSTRACT

A refuse collection vehicle has a chassis, an hydraulic fluid reservoir mounted on the chassis, and a body tiltably supported upon the chassis. The body has two opposed side walls along the interior of which rails extend. A bifurcated partition has an upper part suspended from the rails and a lower part tiltably suspended from the upper part. A tilt cylinder is mounted on the partition upper part and operatively linked with the partition lower part. Means are provided for moving the partition along the rails within said body. An extend trombone hydraulic line provides fluid communication between one end of the tilt cylinder and the chassis mounted hydraulic reservoir and a retract trombone hydraulic line provides fluid communication between an opposite end of the tilt cylinder and the hydraulic reservoir. So constructed, the relative sizes of the forward and rear portion of the vehicle body may be altered and refuse separately discharged therefrom on an automated basis.

### TECHNICAL FIELD

This invention relates to refuse collection vehicles, and more particularly to refuse collection vehicles with multiple compartments.

### BACKGROUND OF THE INVENTION

Refuse collection vehicles have a body into which refuse can be loaded for transport to a collection center or dump. Once there the refused is discharged by tilting the body with its rear end tailgate open.

Often, refuse must be segregated by class. For example, cardboard and paper waste is often collected and then deposited at site while metallic or plastic waste materials are collected and then deposited at another disposal site for recycling Rather than use two vehicles, or have one vehicle make two runs, collection vehicles have been developed capable of hauling two classes of materials segregated from each other. One such vehicle has its body interior formed with two side-by-side compartments separated by a partition that extends fore and aft. These are usually side loaded. Each compartment may be emptied independently of the other by tilting the body with one compartment discharge port or tailgate open and the other closed.

Other compartmentalized refuse collection vehicles have had fore and aft compartments separated by a transverse partition. These too are side loaded. For discharge, the aft or rear compartment is emptied first by tilting the body. The forward compartment is then emptied through the rear compartment by allowing the partition, which is hinged, to tilt as the body itself tilts.

Often a refuse collection vehicle on a run or route needs to collect, transfer and discharge more of one class of waste then another. This leads to the vehicle filling one compartment well before the other is filled. This can in turn mean that the vehicle must leave its route before it is filled to full capacity. Inefficiency results as the vehicle arrives at the dump sites with only one compartment full.

This problem has heretofore been approached by making the transverse partition relocatable within the body. This has been done manually by moving the partition on rollers along supporting tracks having arrays of pin holes and locking the partition in place with pins seated in selected pairs of holes. This has proven to be impractical due to the difficulty of manually handling the heavy partition. The pin holes have also become packed and fowled with debris. Also, this has only been able to be done with the body substantially empty. Thus, adjustments cannot be made during a run even though it often becomes apparent only during a run as to what the ratio will be that day between the classes.

Accordingly, it is seen that a need has long existed for a refuse collection vehicle having multiple compartments whose size may be readily changed on an automated basis. It is to the provision of such that the present invention is primarily directed.

### SUMMARY OF THE INVENTION

In a preferred form of the invention, a refuse collection vehicle has a chassis, an hydraulic fluid reservoir mounted on the chassis, and a body tiltably supported upon the chassis. The body has forward and rear opening into which refuse may be dumped into forward and rear portions. The body also has two opposed side walls along the interior of which rails extend.

A bifurcated partition has an upper part suspended from the rails and a lower part that is tiltably suspended from the upper part. Tilt cylinders are mounted on the partition upper part and operatively linked with the partition lower part. Means are provided for moving the partition along the rails within the body. An extended trombone hydraulic line provides fluid communication between one end of the tilt cylinder and the chassis mounted hydraulic reservoir and a retract trombone hydraulic line provides fluid communication between an opposite end of the tilt cylinder and the hydraulic reservoir. So constructed, the relative sizes of the forward and rear portion of the vehicle body may be altered and refuse separately discharged therefrom on an automated basis.

BRIEF DESCRIPTION OF THE DRAWINGS

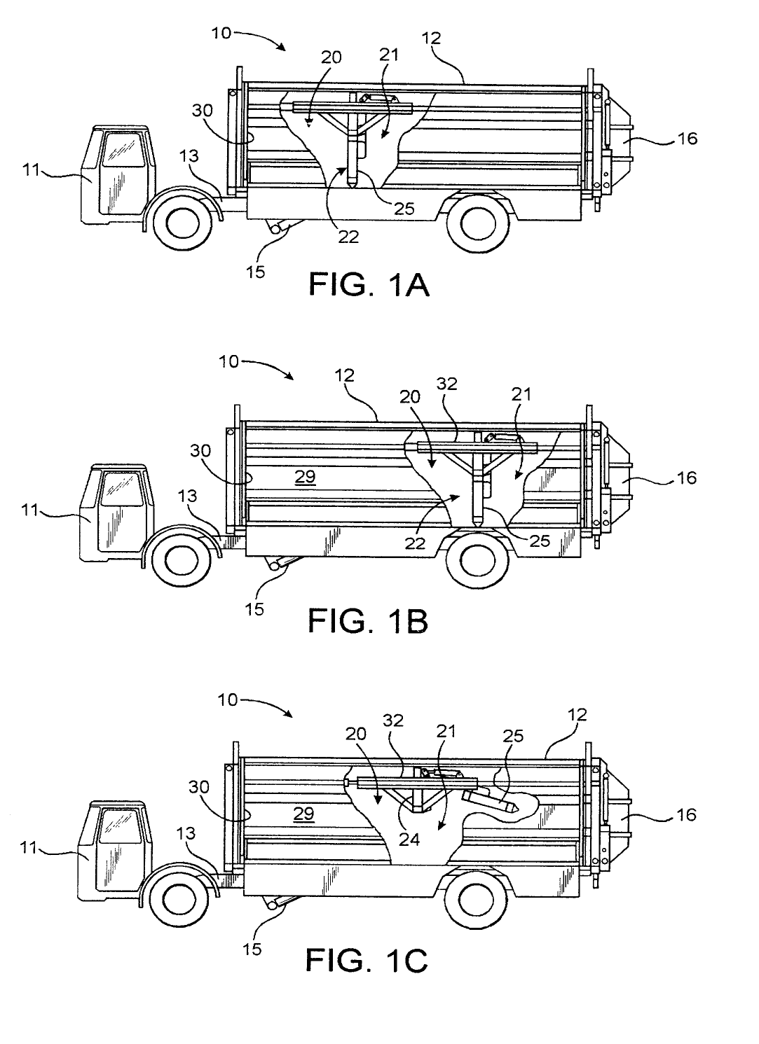

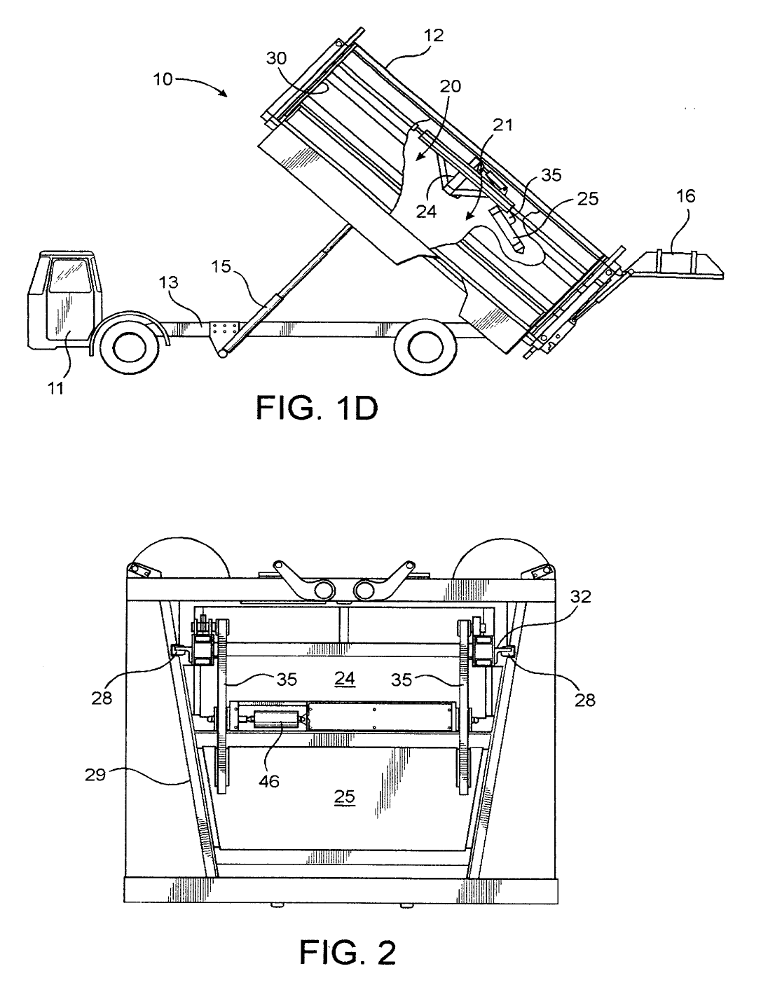

FIGS. 1A-1D are four pictorial views showing four different positions and conditions of the compartments of a refuse collection vehicle that embodies the invention in its preferred form.

FIG. 2 is a view of the rear face of the partition that separates the front and rear refuse storage compartments of the vehicle shown in FIGS. 1A-1D.

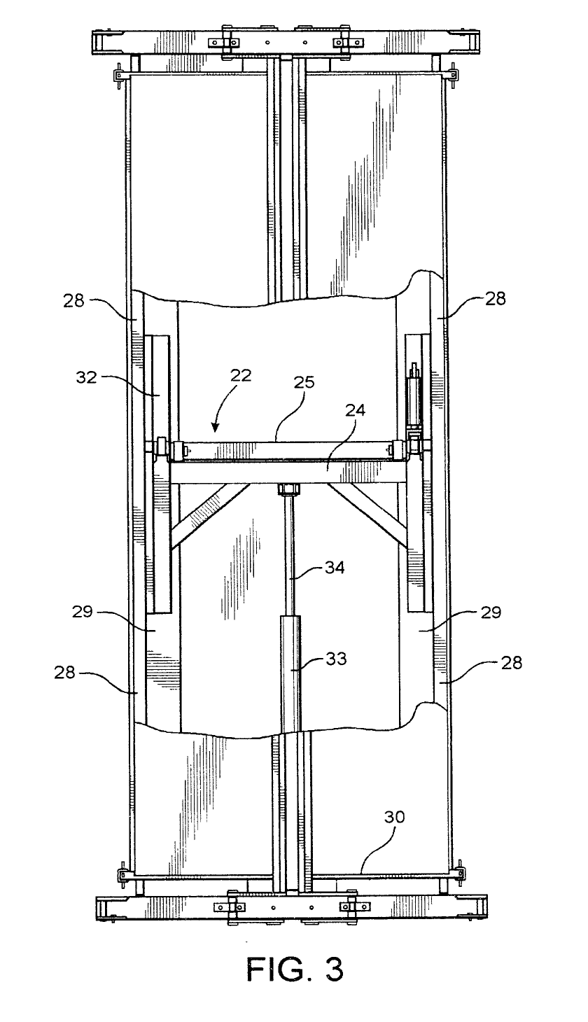

FIG. 3 is a top view of the vehicle body with a portion of the top shown removed to reveal the partition shown in FIG. 2.

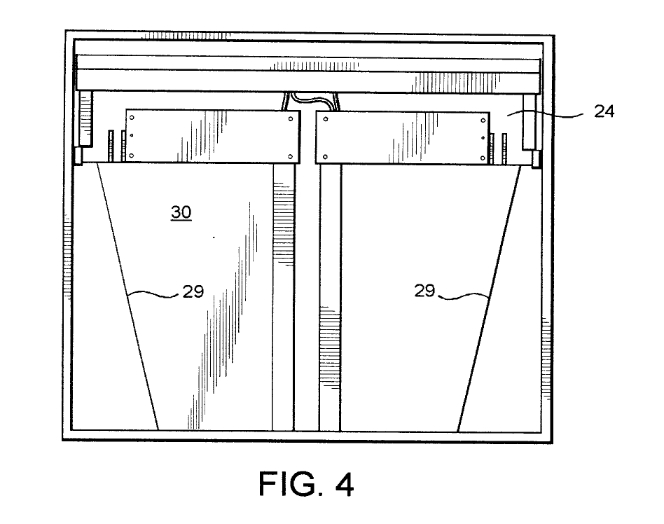

FIG. 4 is a view of the forward face of the partition shown in FIGS. 2 and 3.

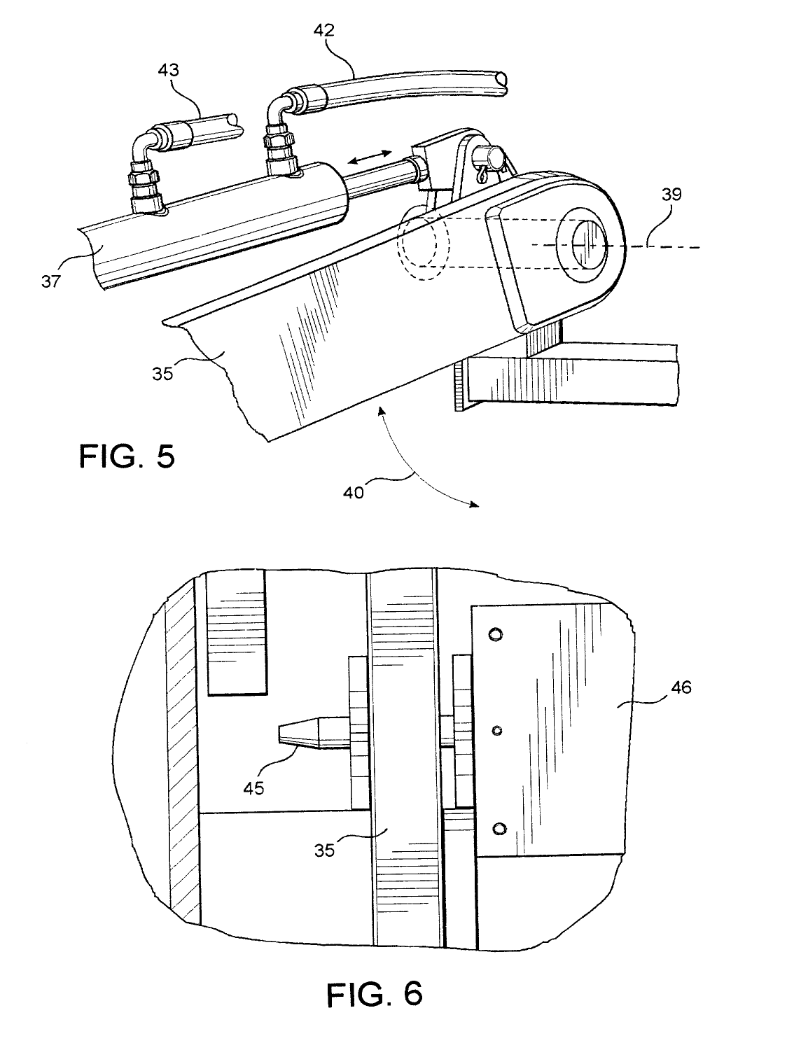

FIG. 5 is a perspective view of linkage used in pivoting a lower part of the partition.

FIG. 6 is a side view of a lock pin used in locking the lower part of the partition in place.

### DETAILED DESCRIPTION

Referring now in more detail to the drawings, there is shown a refuse collection vehicle 10 that embodies principles of the invention in its preferred form. The vehicle has a driver's cab 11 and a body 12 mounted on a chassis 13 The vehicle has a conventional hydraulic power system that includes a hydraulic fluid reservoir mounted on a forward end of the chassis and an associated pump that is driven off the vehicle engine or transmission. The body 12 is hydraulically tiltable from its lowered position shown in FIGS. 1A-1C to its raised, tilted position shown in FIG. 1D by a hydraulic cylinder 15. In its tilted position, refuse may be gravity dumped from the body by raising the tailgate 16 as shown in FIG. 1D.

The interior of the body 12 has a forward storage compartment or space 20 separated from a rear or aft storage compartment or space 21 by a transverse partition shown generally at 22. The partition 22 is bifurcated into an upper part 24 and a lower part 25. With the partition lower part 25 in its down position shown in FIGS. 1A and 1B, there is no substantial spatial communication between the forward space 20 and rear space 21 except near the top of the body. However, with the partition in its raised position shown in FIGS. 1C and 1D, then spatial communication is established between the forward and rear compartments so that refuse may be passed from the forward space into the rear space beneath the partition upper part 24 by gravity feed once the body is tilted. From there the refuse may continue on out of the rear of the vehicle.

The partition upper part 24 is mounted much as a trolley for movement along two slide tracks 28 mounted to the two sloping side walls 29 of the body 12. The side walls extend from the body front wall 30 to the body rear end and the tailgate. The partition upper part is suspended from a carriage 32 that is slidably mounted upon the slide tracks 28. The partition is relocatable within the body by means of a power cylinder 33 and its rod 34. The cylinder is mounted to the body front wall in fluid communication with the hydraulic fluid reservoir. Its rod is mounted to the partition upper part 24 as best shown in FIG. 3.

The partition lower part 25 is mounted to two swing arms 35 that are pivotably mounted to the partition upper part 24 as best shown in FIG. 5. Here each swing or link arm 35 is seen to be rotatably driven by a tilt cylinder 37 that is mounted to the partition upper part 24. Cylinder operation rotates the swing arm about a fixed axis 39 as indicated by arrows 40. Opposed ends of the cylinder 37 are each in fluid communication with the chassis mounted hydraulic system fluid reservoir. This is by means of two “trombone” hydraulic lines, namely an extend line 42 and a retract line 43. Each of these is comprised of two telescopically mounted pipes having an annular seal therebetween. As the partition upper part 24 is relocated within the body 12, the extend and retract lines lengthen or shorten all while providing a fluid conduit between the extend and retract cylinder used in extending and retracting the partition lower part 25.

The refuse collection vehicle also has means for locking the partition lower part 25 in its extended or lowered position shown in FIGS. 1A and 1B. This locking means is best shown in FIG. 6 to comprise two lock pins 45 that are extendable through channels in the swing arms 35 by means of a pressurized air cylinder 46. Note that only one is shown in FIG. 6, the other being on the other side. FIG. 6 shows the partition lower part 25 locked down.

Compressed air is provided to the air cylinder 46 by an extendable and retractable air line 47 in communication with a compressed air tank mounted on the chassis adjacent to the hydraulic fluid reservoir. For clarity of explanation, these have not been shown. However, they are conventionally mounted on the forward end of the chassis behind the cab. The coiled air line is sheathed by a two-piece, telescopic sheath 48. Here it is seen that the pressure cylinder and rod 33, 34, the hydraulic extend and retract lines 42, 43, and air line sheath 48, are all ganged although only the power cylinder and rod are shown in FIG. 3. If desired, the compressed air drive could be, of course, replaced with another hydraulic drive.

In operation, the front and rear compartments may be loaded with two different classes of refuse with the compartments closed off from one another by the partition. Should it become desirable to alter their relative sizes, this may be done by activation of the power cylinder which relocated the petition within the body. As this is done, fluid communication is maintained between the hydraulic fluid reservoir and compressed air tank carried on the chassis and the cylinder carried on the partition for operating and locking the partition lower part and lock pins. For dumping, the body is tilted and the rear compartment emptied with the tailgate open. Later the front compartment may also be emptied by unlocking and raising the partition lower piece and again tilting the body with the tailgate open.

It thus is seen that a refuse collection vehicle is now provided having multiple compartments whose sizes may be readily changed on an automated basis. Although the invention has been illustrated and described in its preferred form, it should be understood that many modifications, deletions and additions may be made thereto without departure from its spirit and scope as set forth in the following claims.

What is claimed is:

1. A refuse collection vehicle having a chassis, a hydraulic fluid reservoir mounted on said chassis, a body tiltably supported upon said chassis and having forward and rear opening into which refuse may be dumped into forward and rear portions of said body, said body having two opposed side walls along the interior of which rails extend; a bifurcated partition having an upper part suspended from said rails and a lower part tiltably suspended from said upper part; at least one tilt cylinder is mounted on said partition upper part and operatively linked with said partition lower part; means are included for moving said partition along said rails within said body; an extended trombone hydraulic line provides fluid communication between one end of said tilt cylinder and said hydraulic reservoir and a retract trombone hydraulic line provides fluid communication between an opposite end of said tilt cylinder and said hydraulic reservoir, whereby the relative sizes of the forward and rear body portions may be altered and refuse separately discharged therefrom by tilting of the body and selective tilting of the partition lower part.

2. The refuse collection vehicle of claim 1 wherein said partition moving means compresses a hydraulic cylinder mounted adjacent to said extend and retract trombone hydraulic lines.

3. The refuse collection vehicle of claim 2 wherein each of said trombone hydraulic lines comprises two telescoping pipes with an annular seal therebetween.

4. The refuse collection vehicle of claim 1 further comprising means for locking said partition lower part in an untilted position blocking movement of refuse between said body forward and rear partitions.

5. The refuse collection vehicle of claim 4 wherein said locking means comprises a compressed air reservoir mounted on said chassis, at least one pneumatic cylinder carried on said partition upper part and a pneumatic line extending between said compressed air reservoir and said pneumatic cylinder with a flexible coiled portion extending adjacent said partition moving means.

6. A refuse collection vehicle having a body, means for tilting said body to dump refuse therefrom; a partition mounted in said body partitioning off a front storage space from a rear storage space; hydraulic means for repositioning said partition to vary the sizes of the front and rear storage spaces; and wherein said partition has a lower part mounted for movement between a position blocking and unblocking the passage of refuse beneath said partition upper portion, and portable hydraulic means carried on said partition upper part for moving said partition lower part between said blocking and unblocking positions.

7. The refuse collection vehicle of claim 6 wherein said portable hydraulic means comprises an hydraulic cylinder carried on said partition upper part, an hydraulic fluid reservoir, and extendable and retractable hydraulic lines providing fluid communication between said hydraulic fluid reservoir and opposed ends of said hydraulic cylinders.

8. The refuse collection vehicle of claim 7 wherein said extendable and retractable hydraulic lines each comprises two telescoping pipes having an annular seal therebetween.

9. The refuse collection vehicle of claim 6 further comprising means for locking said partition lower part in an untilted position blocking movement of refuse between said body forward and rear partitions.

10. The refuse collection vehicle of claim 9 where said locking means comprises compressed air reservoir mounted on said chassis, at least one pneumatic cylinder carried on said partition upper part, and a pneumatic line extending between said compressed air reservoir and said pneumatic cylinder with a flexible coiled portion extending adjacent said partition moving means.
